(19) United States
(12) Patent Application Publication
(10) Pub. No.: US 2009/0213588 A1
(43) Pub. Date: Aug. 27, 2009

(54) Outdoor luminaire using light emitting diodes

(76) Inventor: Robert Joel Manes, Oak IsIand, NC (US)

Correspondence Address: ROBERT JOEL MANES, 108 NW 12th STREET, OAK ISLAND, NC, 28465, US

(21) Appl. No.: 12/030,948

(22) Filed: Feb. 14, 2008

(51) Int. Cl. F21V 1/00; F21V 21/00; F21V 29/00

(52) U.S. Cl. 362/235; 362/373

(57) ABSTRACT

A luminaire that uses Light Emitting Diodes as a light source, and which is intended to be securely mounted outdoors on a pole or arm of widely varying diameter. The luminaire is modular, in the sense that a major component may be removed, repaired and/or replaced for maintenance or for upgrade purposes, without tools, and without modification to any other component in the luminaire. The luminaire's main component is a light engine comprised of Light Emitting Diodes mounted to a thermally conductive circuit board, which in turn is mounted to a thermally dissipative heat sink which resides on the outside of the luminaire. The thermally dissipative heat sink is specifically constructed to take full advantage of horizontal surface winds at the recommended mounting height of the luminaire, to aid in the dissipation of heat created by the Light Emitting Diodes and power components. The Light Engine is mounted in a housing facing downward, with respect to light output, directly over an aperture, or hole in the lower housing, whereby one of several different lenses may be placed to provide a desired photometric output. This structure and method of manufacture allows for use of almost any LED technology that exists, as well as those in the emergent and conceptual stages.

### FIELD OF THE INVENTION

The present invention relates to general street and area lighting and, more particularly, general lighting luminaires using Light Emitting Diodes.

### BACKGROUND OF THE INVENTION

According to the US Department of Energy, current available technologies in the field of lighting may account for up to 19% of the world's energy consumption. In an effort to increase light output for energy expended, lighting methods are employed that seriously endanger our environment. These dangers range from the color of the light output (poor color rendition), to excess light not well-controlled (dark-sky and trespass light pollution and security risks caused by poor visual acuity), to the chemicals included in the operational product, such as mercury, which is used in Low and High Pressure Sodium, Mercury Vapor and fluorescent technologies.

The Light Emitting Diode (LED) has long been used for decorative purposes and as indicators, in everyday applications such as traffic lights on our streets and tail lights on motor vehicles. The use of LEDs is rising in these markets due to decreasing costs of manufacture, energy savings over other technologies and longevity, which results in lowered maintenance costs. As the efficacy of LEDs increase, as measured in lumen output per watt of energy consumed, more manufacturers are looking into LEDs in illumination applications. Great strides in material quality and performance are being made in secondary and tertiary optics, specifically for these brighter LEDs, making them suitable for certain lighting applications for streets, parking lots, and security lighting, to name a few.

The first light produced by electricity was in 1800, attributed to Humphry Davy. It was not until 79 years later that this basic invention was further developed to provide the first “practical” light bulb. To date, this basic design has gone unchanged. Even as we strive to increase efficiency, the fact remains that a majority of the power consumed in the modern light bulb is lost by way of heat generated.

Enter the white LED—whereby light is produced from a solid state device, is highly directional in nature, and has an incredibly long life span. White LEDs contain no mercury and produce no Ultraviolet radiation. LEDs have entered a stage whereby they can be considered for illumination purposes, such as book lights, desk lamps, flashlights and now, street and area lighting. Several companies are attempting to develop street lighting technologies using LEDs retrofitted to existing lighting housings, such as “Cobra” head street lights and “Box” area lighting, but none have developed an economically viable street or area light centered on LEDs.

Developing LED “retrofit” products, that is, products that are meant for installation into existing housings presents certain problems. Ranking number one on the list is the management of heat produced by the LEDs themselves. High ambient temperatures and normal LED operating temperatures severely limit the number of LEDs that can be placed within such a housing, thereby reducing, or limiting, the amount of light produced by these inventions. Without enough light output, the market narrows greatly as lighting requirements and published standards can not be met.

Compact Fluorescent (CF) light bulbs are now widespread in non-commercial settings, such as home lighting, as well as in street and area lighting, and in decorative facade and pathway lighting. Unfortunately, CF lighting also contains mercury and although these products produce more light per watt consumed, they pose an environmental hazard and require proper handling and disposal methods.

Several LED-base street lights have emerged, but these units do not take into account proper light distribution. particularly to meet National and International lighting standards. In addition, these units display poor thermal management, as well as laborious maintenance routines to replace or repair the units.

Further,

It would be advantageous to provide a solid state luminaire, using Light Emitting Diodes, for outdoor lighting,

It would be advantageous to provide a solid state luminaire that managed heat generated by the LEDs using a heat sink that is specifically constructed to take advantage of surface winds,

It would also be advantageous to provide an outdoor luminaire that uses no mercury in its production or operation,

It would further be advantageous to provide a luminaire that requires few or no tools to maintain or upgrade once properly mounted,

It would be advantageous to provide a luminaire that may be optically reconfigured for different lighting requirements,

It would also be advantageous to provide a luminaire with a secure mounting apparatus that will accept mounting arms of a wide range of diameters,

It would further be advantageous to provide a luminaire that accepts various voltage inputs as available to existing outdoor lighting installations,

It would be advantageous to provide a luminaire that accepts voltages using Direct Current (DC), as used in alternative energy applications, such as solar and wind energy generation, to name a few,

It would also be advantageous to provide a luminaire that maintains its color output regardless of power input, through application of precise current control to the LEDs,

It would further be advantageous to provide a luminaire that may utilize any LED technology, and in varying quantity, to achieve required light outputs and to avoid obsolescence.

### SUMMARY OF THE INVENTION

In accordance with the present invention, there is provided a luminaire that uses Light Emitting Diodes as a light source, which is intended to be securely mounted outdoors on a pole or arm of widely varying diameter. The luminaire is modular, in the sense that a major component may be removed, repaired and/or replaced for maintenance or for upgrade purposes, without tools, and without modification to any other component in the luminaire. The luminaire's main component is a light engine comprised of Light Emitting Diodes mounted to a thermally conductive circuit board, which in turn is mounted to a thermally dissipative heat sink which resides on the outside of the luminaire. The thermally dissipative heat sink is specifically constructed to take full advantage of horizontal surface winds at the recommended mounting height of the luminaire, to aid in the dissipation of heat created by the Light Emitting Diodes and power components. The Light Engine is mounted in a housing facing downward, directly over an aperture, or hole in the lower housing, whereby one of several different lenses may be placed, depending upon the lighting requirements of the user. This structure and method of manufacture allows for use of almost any LED technology that exists, as well as those in the emergent and conceptual stages.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a luminaire assembly;

FIG. 2 is an exploded view of a luminaire assembly;

FIG. 3 is a perspective view of a light engine assembly;

FIG. 4 is a perspective view of a heat sink; and

FIG. 5 is a perspective view of a rear housing assembly.

For purposes of clarity and brevity, like elements and components will bear the same designations and numbering throughout the Figures.

### DESCRIPTION OF THE PREFERRED EMBODIMENT

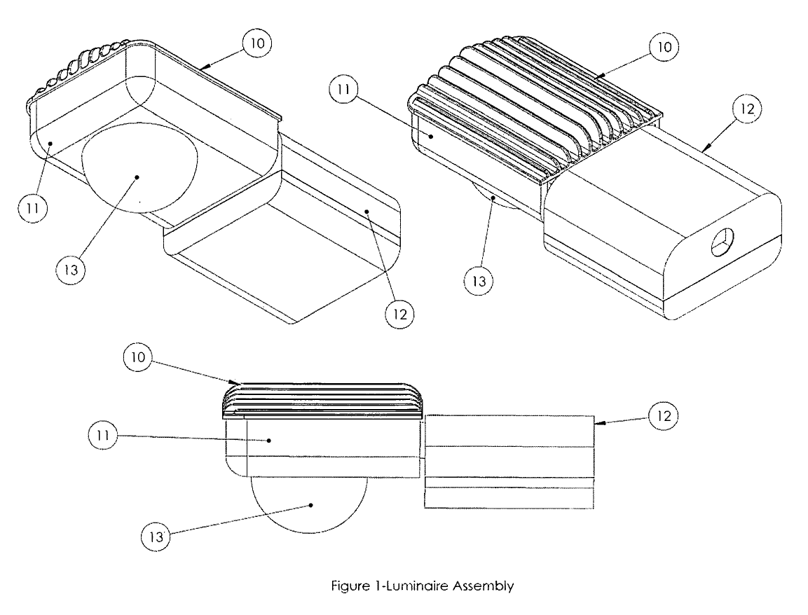

FIG. 1 is a perspective view of the luminaire assembly. This shows the external components of the luminaire in its assembled form. A rear housing 12 is mounted to a main housing 11 via standard hardware, soldering or welding method, as desired. These housings may be made of any material strong enough to support the weight of the components as well as any local, state, or federal regulations or any other recommendations for such a product. A heat sink 10 is placed on top of the main housing 11 and secondary optics 13 are installed below the heat sink 10.

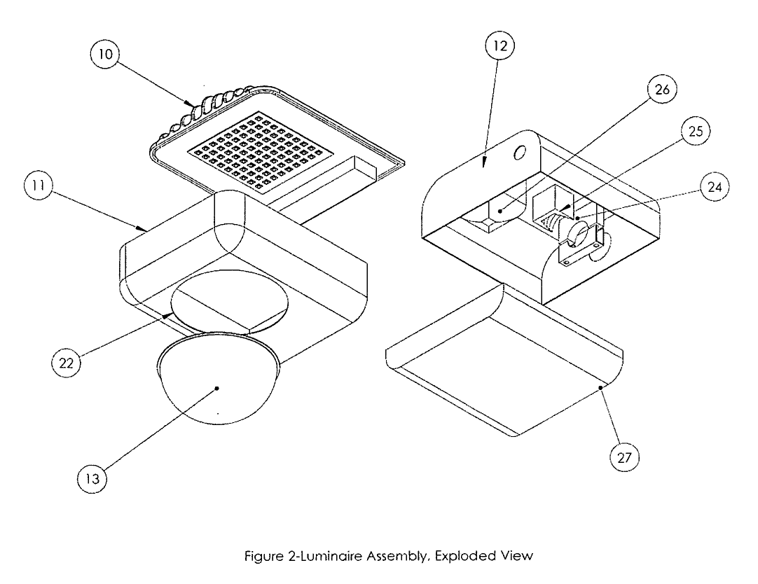

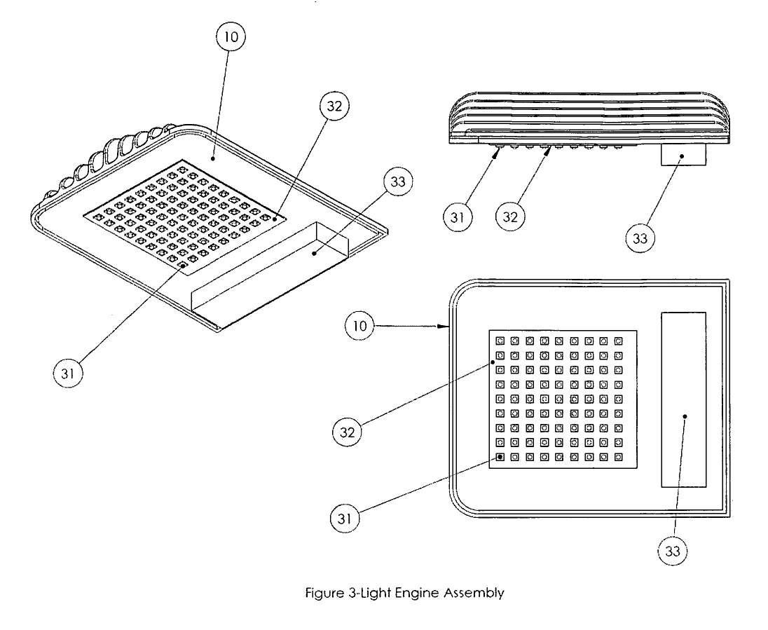

FIG. 2 is an exploded view of the luminaire assembly. The luminaire is mounted on a pole or arm through a hole in the rear housing 12. Depending upon the diameter of the pole or arm, it is placed as far into the front arm mount 25 as the steps will allow, providing a secure fit for a pole or arm of greatly varying diameter. The rear arm mount 24 is then clamped over the pole and secured by means of bolts, screws or tool-less latching mechanism, as preferred by the user. During installation the luminaire pitch and roll may be adjusted by means of the rear arm mount 24. Input electrical power is connected to the primary power regulator 26 within the rear housing 12, via a pre-formed plug, solder or screw-type connections. The primary power regulator 26 accepts power input from grid-type power sources, or from alternative power sources, such as solar or wind generated. The primary power regulator 26 converts the input power to the correct voltages and current required by the secondary power regulator 33, which is located on the light engine assembly (FIG. 3).

FIG. 3 is a perspective view of the light engine assembly. Power is delivered from the primary power regulator 26 to the secondary power regulator 33, which, in turn, precisely controls the current delivered via the printed circuit board 32 to the light emitting diodes 31. This current control insures constant color output from the light emitting diodes 31 and extends the life of the light emitting diodes 31 by regulating heat caused by current. The light emitting diodes 31 are thermally bonded to the printed circuit board 32 to allow for maximum heat transfer from the light emitting diodes 31 to the printed circuit board 32. The printed circuit board 32 is bonded to the polished surface 41 of the heat sink 10 with thermal epoxy or any other thermal adhesive materials to insure maximum heat delivery from the LEDs through the printed circuit board 32 to the heat sink 10.

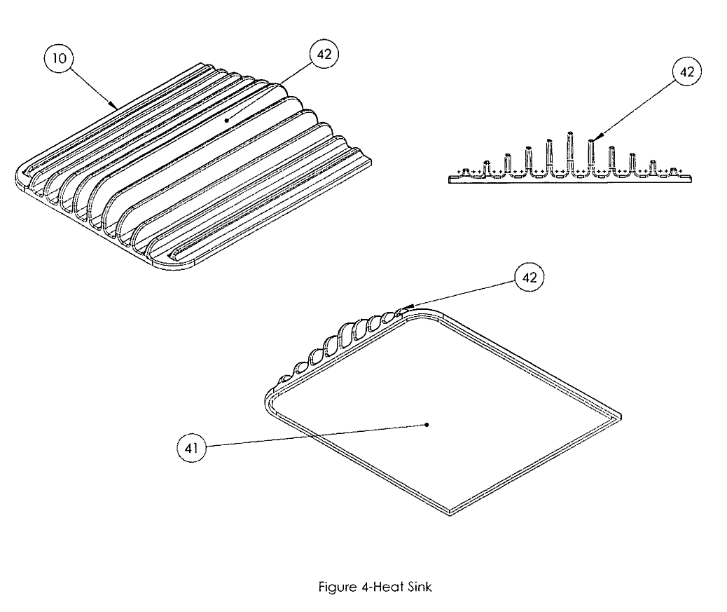

FIG. 4 is a perspective view of the light engine heat sink 10. The light engine heat sink 10 may be made of any rigid, thermally conductive material, such as aluminum. The fins 42 of the heat sink 10 are aligned symmetrically along the lengthwise axis of the luminaire, with a stepped configuration and a graduated taper towards the outer edges of the light engine. This configuration maximizes the heat sink's ability to expel heat generated by the light emitting diodes 31 and secondary power regulator 33 by taking full advantage of horizontal surface wind that is regularly present at the suggested mounting height of the luminaire. As each of the fins 42 extends to a different height, and each of the fins 42 has a different taper angle, more wind is allowed to penetrate deeper into the fins 42 structure, breaking thermal tension present along the surface of each of the fins 42. The heat sink 10 is placed on the main housing 11 and effectively creates a seal to protect the components within the main housing 11 from weather. The light engine also serves to correctly align the light emitting diodes 31 over the optical aperture 22 to insure consistent light delivery from the luminaire. With reference to FIG. 1 and FIG. 2, the optical aperture 22 serves to capture and align the secondary optics 13, where light from the light emitting diodes 31 is manipulated into the desired photometric projection. The secondary optic may be made from any optically favorable material, including glass, acrylic, luminaire-grade plastics or reflective nano-materials. The color of the secondary optics 13 may be that which provides light projection in a frequency required or desired by the user, to include those colors that are favorable to certain environmental requirements, as is the case with Red or Red-Orange area lighting used to preserve marine life in coastal applications. The shape of the secondary optics 13 may range from flat glass to certain shapes required to provide photometrically correct outputs for use in streets, highways, intersections or general pathway lighting, to name a few.

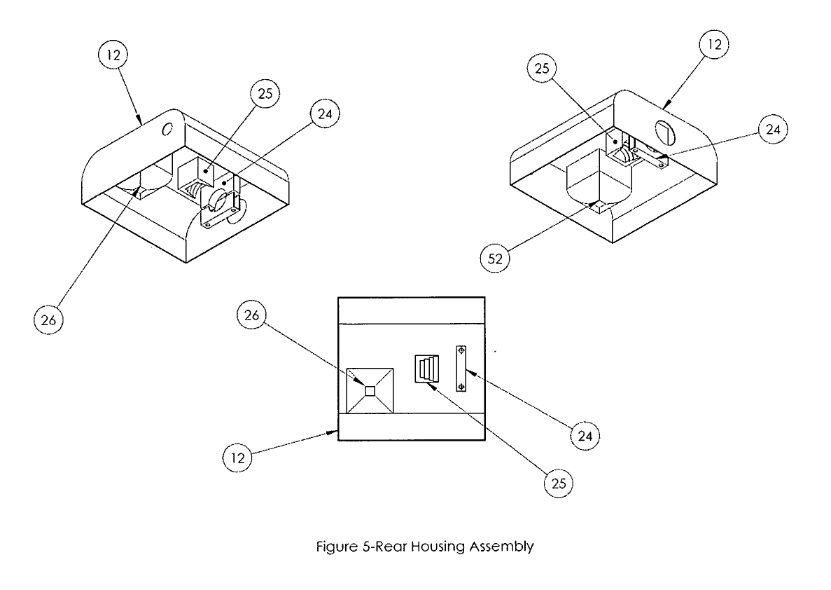

FIG. 5 is a perspective view of the rear housing 12 assembly.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An outdoor luminaire using light emitting diodes for street, pathway and general area lighting, comprising:
a means to provide protected access for installing the electrical connections to power the luminaire;
a means for proper alignment of the secondary optic and the light emitting diodes in order to provide for correct light shaping and maximum luminous intensity, with respect to user requirements;
a means for securing the luminaire to almost any size arm or pole, allowing for correct orientation of the luminaire, with regard to pitch and roll;
a means for supplying the light emitting diodes with power that is precisely regulated and protected with regard to current, ensuring light emitting diode longevity goals and light output are met;
a means for providing for a heat sink with large surface areas from which to dissipate heat from the light emitting diodes.

2. The outdoor luminaire using light emitting diodes in accordance with claim 1, wherein said means for proper dissipation of heat are fins that are of varying height to provide a greater area for heat to escape, the highest fin, and therefore that with the greatest surface area, located in the center of the heat sink, in accordance with greater concentration of heat from the light emitting diodes. Said fins are also rounded/tapered to allow for maximum airflow from any horizontal direction, allowing surface wind to break thermal tension over a greater area.

3. The outdoor luminaire using light emitting diodes in accordance with claim 1, wherein said means for proper alignment of the secondary optic and the light emitting diodes is via an optical aperture, and is in order to provide for consistent light shaping and maximum luminous intensity.

4. The outdoor luminaire using light emitting diodes in accordance with claim 1, wherein said means for securing the luminaire to and arm or pole, whereby the rear arm mount allows for correct orientation of the luminaire, with regard to pitch and roll, and maintains the depth of penetration of the mounting arm or pole into the luminaire's rear housing, and the front arm mount, with its stepped design eliminates “yaw” of luminaire when properly mounted, and unique graduation (steps) allow for secure mounting of almost any size arm or pole.

5. The outdoor luminaire using light emitting diodes in accordance with claim 1, wherein said means for controlling heat generation is by precise current control to the light emitting diodes.

6. The outdoor luminaire using light emitting diodes in accordance with claim 1, wherein said means for routing power to the light emitting diodes and properly distributing heat to the heat sink is via a thermally conductive printed circuit board, which is thermally bonded to said heat sink.

7. The outdoor luminaire using light emitting diodes in accordance with claim 1, wherein said means for providing the desired light output is by use of secondary optics, that which may be manufactured using any one of several different materials and/or colors and/or shapes to achieve the desired effect and to meet application requirements.

8. The outdoor luminaire using light emitting diodes in accordance with claim 1, wherein once installed, requires no tools to upgrade or provide maintenance to luminaire components.
